(19) United States
(12) Patent Application Publication
(10) Pub. No.: US 2025/0318031 A1
(43) Pub. Date: Oct. 9, 2025

(54) LED DRIVER CIRCUIT FOR GENERATING WIPING EFFECT

(71) Applicant: Infineon Technologies AG, Neubiberg (DE)

(72) Inventors: Riccardo ZUIN, Saonara (IT); Anastasia IOANNIDOU, Padova (IT)

(21) Appl. No.: 19/061,406

(22) Filed: Feb. 24, 2025

(30) Foreign Application Priority Data
Apr. 4, 2024 (DE) 102024109444.3

(51) Int. Cl. H05B 47/155; B60Q 1/38; H05B 45/34; H05B 47/16

(52) U.S. Cl. CPC H05B 47/155; B60Q 1/381; H05B 45/34; H05B 47/16; B60Q 2900/40

(57) ABSTRACT

A circuit for driving a plurality of LEDs includes a plurality of channels, wherein each channel has an enable input and is configured to regulate—when enabled—a load current flowing from an output node to a sense node of the respective channel. The current regulation is based on a reference voltage and a sense voltage present at the sense node of the respective channel. The circuit further includes a main sense resistor connected to the sense node of a first channel of the channels and one or more additional sense resistors, wherein the sense node of each channel is connected to a sense node of a neighboring channel via one of the additional sense resistors. A chain of LEDs is coupled to the circuit, and the output node of each channel is connected to an output node of a neighboring channel via at least one LED of the chain of LEDs and wherein an input node is connected to the output node of a last channel of the channels via at least one LED of the chain of LEDs. Moreover, the circuit includes an analog delay circuit including a capacitor connected to the enable input of the first channel, wherein the enable input of each channel is connected to the enable input of a neighboring channel via a resistor and wherein the enable input of the last channel is coupled to a voltage source configured to provide a voltage based on the voltage present at the input node.

### TECHNICAL FIELD

The present disclosure relates to the field of Light-Emitting Diode (LED) driver circuits, which may be used, for example, to drive LED turn signals of automobiles or motorcycles.

### BACKGROUND

LEDs are increasingly replacing conventional light bulbs in a large variety of lighting applications. In particular in modern automobiles headlights, turn indicators or the like include LEDs instead of light bulbs. Unlike light bulbs, LEDs operate at a constant current and cannot simply be connected to a voltage source (e.g. an automotive battery). So-called LED driver circuits (LED drivers) are used to generate, from a supply voltage, the operating current required for a LED or a series circuit of LEDs.

So called “wiping turn indicators” have become very popular. Such turn indicators include a series of LEDs which are sequentially switched on and off to achieve a kind of wiping effect. However, when using LED drivers in a conventional way, the sequence according to which the LEDs are switched on and off, usually has to be generated by a microcontroller, which increases the overall costs of the wiping turn indicator.

### SUMMARY

A circuit for driving a plurality of LEDs is described herein. In one embodiment, the circuit includes a plurality of channels, wherein each channel has an enable input and is configured to regulate-when enabled-a load current flowing from an output node to a sense node of the respective channel. The current regulation is based on a reference voltage and a sense voltage present at the sense node of the respective channel. The circuit further includes a main sense resistor connected to the sense node of a first channel of the channels and one or more additional sense resistors, wherein the sense node of each channel is connected to a sense node of a neighboring channel via one of the additional sense resistors. A chain of light emitting diodes is coupled to the circuit, wherein the output node of each channel is connected to an output node of a neighboring channel via at least one LED of the chain of LEDs and wherein an input node is connected to the output node of a last channel of the channels via at least one LED of the chain of LEDs. Moreover, the circuit includes an analog delay circuit including a capacitor connected to the enable input of the first channel, wherein the enable input of each channel is connected to the enable input of a neighboring channel via a resistor and wherein the enable input of the last channel is coupled to a voltage source configured to provide a voltage based on the voltage present at the input node.

### BRIEF DESCRIPTION OF THE DRAWINGS

The invention can be better understood with reference to the following drawings and descriptions. The components in the figures are not necessarily to scale; instead emphasis is placed upon illustrating the principles of the invention. Moreover, in the figures, like reference numerals designate corresponding parts. In the drawings:

FIG. 1 illustrates an example of a LED driver circuit for three LEDs, wherein a wiping effect is achieved with the help of a microcontroller that generates the switch-on/off sequence for the LEDs.

FIG. 2 is a timing diagram illustrating the sequential switching on and off of the LEDs.

FIG. 3 illustrates a LED driver circuit which uses a conventional driver chip in an innovative way in order to generate the switch-on/off sequence for the LEDs without the need for a microcontroller.

FIG. 4 is a timing diagram illustrating the function of the circuit of FIG. 3.

### DETAILED DESCRIPTION

In the following detailed description, reference is made to the accompanying drawings. The drawings form a part of the description and, for the purpose of illustration, show examples of how the embodiments may be used and implemented. It is to be understood that the features of the various embodiments described herein may be combined with each other, unless specifically noted otherwise.

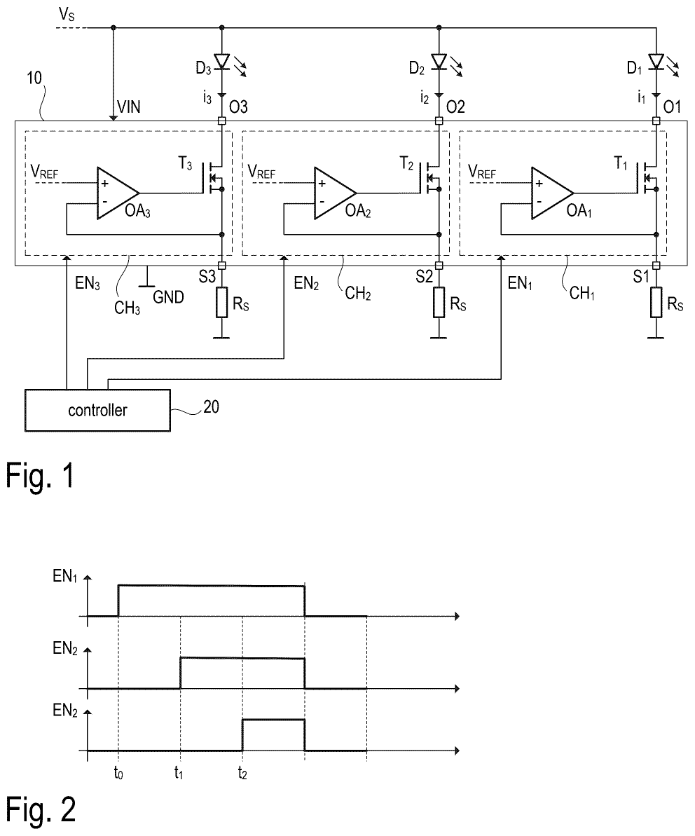

FIG. 1 illustrates a conventional integrated circuit (IC) 10 with a three-channel LED driver circuit for driving three LEDs (or LED chains) and the external circuitry (microcontroller and current sense resistors R_{S}), which is necessary to operate the IC. The IC 10 has three channels CH₁, CH₂, and CH₃, wherein an output pins (output node) is associated with each channel. The output pins are denoted O1, O2, and O3 in the present example, wherein one LED (or a chain/series circuit of LEDs) is connected between each output node and a supply line. The LEDs are denoted as D₁, D₂ and D₃, wherein D₁ is coupled to output pin O1, D₂ is coupled to output pin O2, and D₃ is coupled to output pin O3. The supply line may be coupled, for example, to an automotive battery that provides a supply voltage V_{S} (e.g. V_{S}≈12-14 V). For example, in automotive applications, the supply voltage V_{S} is provided by so-called “terminal 15” defined in the standard DIN 72552 (standard for labeling the electric terminals in automotive wiring). The supply pin of the IC 10 is labelled VIN in the depicted example. The ground potential is labelled GND (e.g. connected to “terminal 31”).

Furthermore, the IC 10 has a sense pin (sense node) associated with each channel. In the depicted example, the sense node associated with channel CH₁ is denoted S1, the sense node associated with channel CH₂ is denoted S2, and the sense node associated with channel CH₃ is denoted S3. Each channel of the IC 10 includes a power transistor (transistors T₁, T₂, and T₃), wherein the load current path of the power transistor couples the output node with the sense node of the respective channel. In the present example, the power transistors are Metal-Oxide-Semiconductor (MOS) Field-Effect Transistors (FETs). It is understood, however, that other types of transistors may be used instead of MOSFETs. In the depicted example, the drain-source current path of transistor T₁ of channel CH₁ connects the output node O1 with the corresponding sense node S1, wherein the source electrode of the transistor is connected to the sense node S1. The channels CH₂ and CH₃ are implemented in the same way.

To provide a constant load current i₁ (which is sunk at the output node O1 of channel CH₁), the transistor T₁ is driven by an operational amplifier OA₁, whose inverting input is connected to the source electrode of the transistor T₁ and whose non-inverting input receives a reference voltage V_{REF}. The reference voltage V_{REF} may be provided, e.g. by a bandgap-reference or any other reference circuit capable of providing a reference voltage. During operation, the voltage drop across the sense resistor R₁ (connected to sense pin S1) equals R₁·i₁, and—due to the feedback of the sense voltage R₁·i₁ to the inverting input of the operational amplifier OA₁—the operational amplifier OA₁ drives the transistor T₁ such that the sense voltage R_{S}·i₁ (substantially) equals the reference voltage V_{REF}. This also means that i₁=V_{REF}/R_{S} (i₁ is constant and determined by V_{REF} and R_{S}). As all channels are constructed in the same way, the output currents i₁, i₂, and i₃ are equal (i₁=i₂=i₃=V_{REF}/R_{S}). In essence, the operational amplifiers, together with the transistors, implement a current regulation which keeps the load currents at the output nodes constant (when the respective channel is enabled) although the supply voltage V_{S} may vary.

Each channel can be enabled by a respective enable signal. In the depicted example, the IC 10 has three chip pins for receiving the enable signals EN₁, EN₂, EN₃ which are associated with channel CH₁. CH₂, and CH₃, respectively. Enabling and disabling the channels may be accomplished, for example, by enabling/disabling the respective operational amplifier or by enabling/disabling the respective transistor (e.g. by connecting/disconnecting the transistor's gate and ground potential).

The enable signals EN₁, EN₂, EN₃ are generated by the microcontroller 20. An exemplary sequence is shown in the timing diagrams of FIG. 2. Accordingly, the enable signal EN₁ has a high level between time instants t₀ and t₃, the enable signal EN₂ has a high level between time instants t₁ and t₃, and the enable signal EN₃ has a high level between time instants t₂ and t₃. As a result, the LEDs D₁, D₂, and D₃ are switched on one after another, which results in the wiping effect when the LEDs are mounted in a row in a lighting device such as a turn indicator.

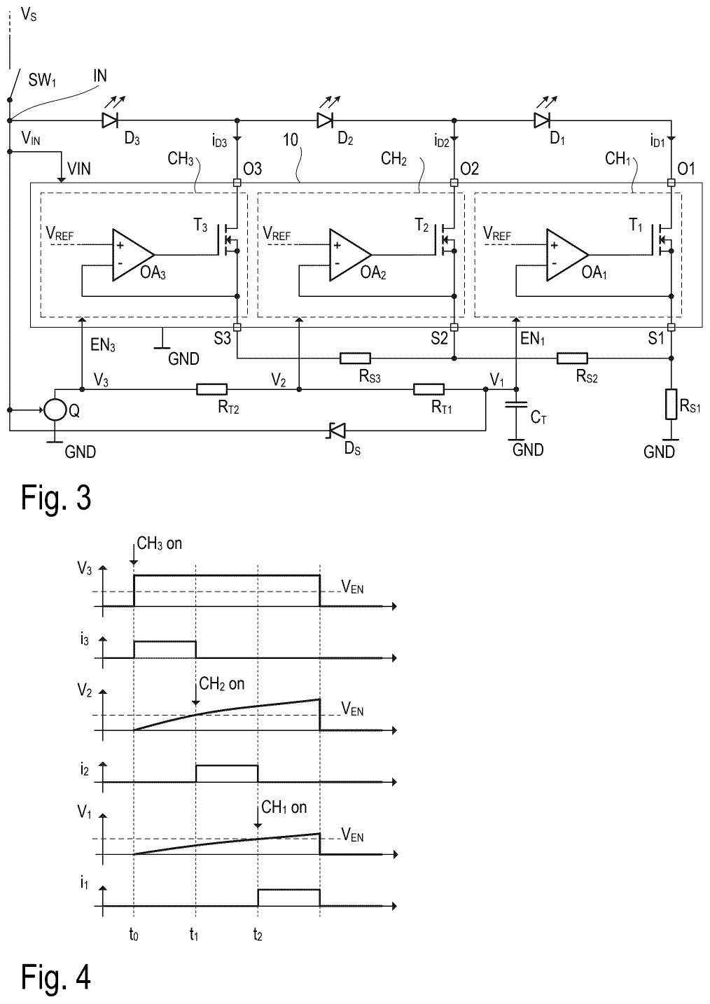

As mentioned the need for a microcontroller increases the costs of the overall system. In the time interval from (see FIGS. 2, t₂ to t₃), in which all three LEDs are on, power is dissipated in all channels of the IC 10. In some applications, this may make necessary a so-called power-shift feature, which is as such known and which also increases the complexity of the overall system. The example of FIG. 3 illustrates an innovative way of using a multi-channel LED driver IC such that the microcontroller can be replaced by less expensive circuit components. Furthermore, the concept shown in FIG. 3 can reduce the power dissipation as only one channel dissipated power at a time.

In the example of FIG. 3 the IC 10 is substantially the same as in the circuit of FIG. 1 and reference is made to the above explanations to avoid unnecessary reiterations. However, the LEDs and the current sense resistors are connected to the IC in a different way. Generally. the IC10 includes a plurality of channels CH₁, CH₂, CH₃, wherein each channel CH₁, CH₂, CH₃ has an enable input (for receiving enable signals EN₁, EN₂, EN₃) and is configured to regulate (when enabled) a load current i_{D1}, i_{D2}, i_{D3} flowing from the output node O1, O2, O3 to the sense node S1, S2, S3 of the respective channel. As mentioned the current regulation is based on a reference voltage V_{REF} and a sense voltage present at the sense node S1, S2, S3 of the respective channel.

The LEDs are connected differently than in the circuit of FIG. 1. Accordingly, the LEDs are connected in series to form a chain of LEDs, wherein the output node of each channel is connected to an output node of a neighboring channel via (at least) one LED. In the depicted example, the LED D₁ is connected between output node O1 and the neighboring output node O2 and the LED D₂ is connected between output node O2 and the neighboring output node O3. Furthermore, (at least) one LED (i.e. D₃ in the depicted example) is connected between the output node of the last channel (i.e. O3 in the depicted example) and an input node IN which receives an input voltage V_{IN}. The input node IN is connected the supply line (voltage V_{S}) via an electronic switch SW₁, i.e. V_{IN} substantially equals V_{S} when the switch is closed. In a turning indicator the switch SW₁ may be regularly closed and opened to implement an intermittent light as it is usually the case in a turning indicator. For example, the switch SW₁ may be an (e.g. electronic) relay or the like. As can be seen in FIG. 3, when only channel CH₁ is active, all three LEDs will be on (active) but only the load current i_{D1} causes power dissipation in channel CH₁ while almost no power is dissipated in the other channels.

The current sensing is implemented differently than in the circuit of FIG. 1. Accordingly, a main sense resistor R_{S1} is connected to the sense node S1 of a first channel CH₁, wherein the sense node of each channel is connected to a sense node of a neighboring channel via one (o a series of) additional sense resistors. In the depicted example, the sense node S3 is connected to the neighboring sense node S2 via resistor R_{S3}, and the sense node S2 is connected to the neighboring sense node S1 via resistor R_{S2}, wherein the main sense resistor R_{S1} is connected between the sense node S1 and ground potential (GND). The effect of this specific arrangement of sense resistors will be explained further below with reference to FIG. 4.

The circuit of FIG. 3 further includes an analog delay circuit that is coupled to the enable inputs of the channels CH₁, CH₂, CH₃. The delay circuit incudes a capacitor C_{T} that is connected between ground (or another reference potential) and the enable input of the first channel CH₁. Further, the enable input of each channel is connected to the enable input of a neighboring channel via a resistors, and the enable input of the last channel CH₃ is coupled to a voltage source Q (or alternatively a current source). Accordingly, in the depicted example, a first resistor R_{T1} is connected between the enable input (EN₁) of the first channel CH₁ and the enable input (EN₂) of the (neighboring) second channel CH₂. Similarly, a second resistor R_{T2} is connected between the enable input (EN₂) of the second channel CH₂ and the enable input (EN₃) of the (neighboring) third channel CH₃. The voltage V₃ provided by the voltage source Q may depend on the input voltage V_{IN}. The voltage source Q may provide a stabilized voltage V₃, which helps to achieve a defined timing behavior of the delay circuit. In this context “stabilized” means that the voltage source Q has a low temperature gradient and a high PSRR (power supply rejection ratio). In one example, the voltage source Q may be integrated in the IC 10, and the voltage V₃ may be based on the input voltage V_{IN}, which supplies the IC 10. AS shown in the depicted examples, the channels CH1, CH2, and CH3 are integrated in a semiconductor chip package of the IC 10 and the output nodes O1, O2, and O3 as well as the sense nodes S1, S2, S3 are connected to respective chip contacts of the chip package of the IC 10. Also the voltage V₃ may be output at a chip contact (pin). The delay circuit and the sense resistors are may be arranged outside the chip package and implemented using discrete components.

The function of the circuit of FIG. 3 is further discussed with reference to the timing diagrams of FIG. 4. The first, the third and the fifth diagram (from the top) illustrate the voltages V₃, V₃, and V₁ present at the enable inputs E₃, E₂, and E₁, respectively, of the channels CH₃, CH₂, and CH₁. The second, fourth and sixth diagram illustrate the load currents i_{D3}, i_{D2}, and i_{D1} sunk at output nodes O3, O2, and O1, respectively.

The voltage V₃ at enable input EN₃ is determined by the voltage source Q, which is activated/deactivated in accordance with the input voltage V_{IN} and the switch SW₁. In the depicted example, V₃ changes to a High level at time instant to (as switch SW₁ is closed). Assuming the capacitor C_{T} is discharged at time instant to, the voltages V₁ and V₂ are zero at time instant to. Starting at time instant to, the voltages V₁ and V₂ increase while the capacitor Cr is charged by the current provided by voltage source Q. The steepness of the voltage increase (dV₁/dt and dV₂/dt) depends on the capacitance of capacitor C_{T} and the resistances of resistors R_{T1} and R_{T2}, wherein V₁ is lower than V₂ (because R_{T1} and R_{T2} form a voltage divider). The voltage V₂ at the enable input E₂ of the second channel CH₂ reaches the enable threshold VEN at time instant t₁, and the voltage V₁ at the enable input E₁ of the first channel CH₁ reaches the enable threshold VEN at time instant t₂. The capacitor C_{T} and the resistors R_{T1} and R_{T2} may be designed such that the time intervals t₁−t₀ and t₂−t₁ are approximately equal. When V₂ reaches and exceeds the threshold VEN, the second channel CH2 is enabled, and when V₁ reaches and exceeds the threshold VEN, the first channel CH2 is enabled.

When channel CH₃ is enabled at time instant to the operational amplifier OA₃, together with transistor T₃ regulates the current i_{D3} passing through LED D₃ such that the voltage drop i_{D1}·(R_{S1}+R_{S2}+R_{S3}) across the current sense resistors substantially equals the reference voltage V_{REF}. Only LED D₃ is active in this phase as channels CH₂ and CH₁ are disabled.

When channel CH₂ is enabled at time instant t₁ the operational amplifier OA₂, together with transistor T₂ will regulate the current i_{D2} passing through LED D₂ such that the voltage drop i_{D2}·(R_{S1}+R_{S2}) across the current sense resistors substantially equals the reference voltage V_{REF}. As soon as channel CH₂ becomes active, the current regulation loop in channel CH₃ will cause a switch-off of transistor T₃ (thus deactivating the channel CH₃), because even a very small load current i_{D3} would lift the voltage at sense node S3 above the reference voltage V_{REF}, which causes the operational amplifier OA₃ to switch the transistor T₃ off. Consequently, the channel CH₃ is “automatically” disabled by the current regulation loop of CH₃ as soon as channel CH₂ becomes active.

Similarly, when channel CH₁ is enabled at time instant t₂ the operational amplifier OA₁, together with transistor T₁ will regulate the current i_{D1} passing through LED D₁ such that the voltage drop i_{D1}·R_{S1} across the current sense resistor R_{S1} substantially equals the reference voltage V_{REF}. As soon as channel CH1 becomes active, the current regulation loop in channel CH₂ will cause a switch-off of transistor T₂ (thus deactivating the channel CH₂), because even a very small load current i_{D2} would lift the voltage at sense node S2 above the reference voltage V_{REF}, which causes the operational amplifier OA₂ to switch the transistor T₂ off. Consequently, the channel CH₂ is “automatically” disabled by the current regulation loop of CH₂ as soon as channel CH1 becomes active.

It is noted that, in the example of FIGS. 3 and 4 the load current i_{D1} passes through all three LEDs D₁, D₂, and D₃. The load current i_{D2} passes only through two of the three LEDs, namely D₂ and D₃. Finally, the load current i_{D3} passes only through one of the three LEDs, namely D₃. The visible result, i.e. the wiping effect is practically the same as in the example of FIG. 1 but the power dissipation within the IC 10 is significantly reduced. In this context, it is noted that the resistors R_{S2} and R_{S3} may have a very small resistance as compared to resistor R_{S1}. That is, the ratios R_{S1}/(R_{S1}+R_{S2}) and R_{S1}/(R_{S1}+R_{S2}+R_{S3}) are approximately one. For many applications, this approximation is acceptable. If not, the current i_{D3} may be somewhat lower than i_{D2}, and the current i_{D2} may be somewhat lower than i_{D1}, dependent on the resistance values of R_{S2} and R_{S3}.

When the switch SW1 is switched off, the capacitor C_{T} of the delay circuit has to be discharged before the next switch-on. This may be accomplished, for example by a diode D_{S} that is coupled between the capacitor C_{T} and the input node VIN. In one example, the diode D_{S} is a Schottky diode which has a significantly lower forward voltage as compared to normal silicon diodes. In other embodiments, the diode D_{S} may be replaced by a transistor or any other electronic switch which, in essence, short-circuits the capacitor at time instant t3 (see FIG. 4).

As mentioned, the input node VIN may be connected to a power supply (e.g. an automotive battery) providing a supply voltage V_{S} via the switch SW₁. The input node VIN is pulled towards ground potential GND (by the IC 10) when the switch SW₁ is switched off. The analog delay circuit may be configured to discharge the capacitor C_{T} when the switch SW₁ is switched off, wherein the discharging can be accomplished by connecting the capacitor to the input node V_{IN} (e.g. via the mentioned Schottky diode) because the node V_{IN} is at ground potential when the switch SW₁ is open (off).

The basic purpose of the channels is the current regulation. In the embodiments described herein, this may be accomplished, in each channel, by a transistor that has a control electrode and a load current path, which is coupled between the output node and the sense node of the respective channel, and a regulator (e.g. an operational amplifier) that is configured to drive the control electrode of the transistor such that a difference between a reference voltage V_{REF} and the a sense voltage present at the sense node of the respective channel is minimized. Instead of an operational amplifier a more complex circuit may be used (e.g. a proportional-integral (PI) regulator).

Although the invention has been illustrated and described with respect to one or more implementations, alterations and/or modifications may be made to the illustrated examples without departing from the spirit and scope of the appended claims. In particular regard to the various functions performed by the above described components or structures (units, assemblies, devices, circuits, systems, etc.), the terms (including a reference to a “means”) used to describe such components are intended to correspond-unless otherwise indicated—to any component or structure, which performs the specified function of the described component (e.g., that is functionally equivalent), even though not structurally equivalent to the disclosed structure, which performs the function in the herein illustrated exemplary implementations of the invention.

1. A circuit comprising:
a plurality of channels, wherein each channel has an enable input and is configured to regulate, when enabled, a load current flowing from an output node to a sense node of the respective channel based on a reference voltage and a sense voltage present at the sense node of the respective channel;
a main sense resistor connected to the sense node of a first channel of the channels;
one or more additional sense resistors, wherein the sense node of each channel is connected to a sense node of a neighboring channel via one of the additional sense resistors;
a chain of light emitting diodes (LEDs), wherein the output node of each channel is connected to an output node of a neighboring channel via at least one LED of the chain of LEDs;
an input node which is connected to the output node of a last channel of the channels via at least one LED of the chain of LEDs;
an analog delay circuit including a capacitor connected to the enable input of the first channel, wherein the enable input of each channel is connected to the enable input of a neighboring channel via a resistor, and wherein the enable input of the last channel is coupled to a voltage source configured to provide a voltage based on the voltage present at the input node.

2. The circuit of claim 1,
wherein the input node is connected to a power supply providing a supply voltage via a switch.

3. The circuit of claim 1,
wherein the input node is pulled towards ground potential when the switch is switched off.

4. The circuit of claim 1,
wherein the analog delay circuit is configured to discharge the capacitor when the switch is switched off.

5. The circuit of claim 1,
wherein the analog delay circuit includes a diode coupled between the capacitor and the input node.

6. The circuit of claim 1, wherein each channel includes:
a transistor having a control electrode and a load current path, which is coupled between the output node and the sense node of the respective channel, and
a regulator, which is configured to drive the control electrode of the transistor such that a difference between a reference voltage and the sense voltage present at the sense node of the respective channel is minimized.

7. The circuit of claim 6,
wherein the regulator is an operational amplifier whose output is connected to the control electrode of the transistor of the respective channel.

8. The circuit of claim 1,
wherein the voltage source is a stabilized voltage source with regard to variations of input voltage and/or temperature.

9. The circuit of claim 1,
wherein the plurality of channels are integrated in a semiconductor chip package and
wherein the output nodes and the sense nodes are connected to respective chip contacts of the chip package.

10. The circuit of claim 9,
wherein the voltage source is integrated in the chip package and the voltage provided by the voltage source is output at a chip contact of the chip package.

11. The circuit of claim 9,
wherein the delay circuit and the sense resistors are arranged outside the chip package.
